(19) United States
(12) Patent Application Publication
(10) Pub. No.: US 2019/0127535 A1
(43) Pub. Date: May 2, 2019

(54) USE OF A PLASTIC CONTAINING ANTIMICROBIAL ACTIVE SUBSTANCE TO MANUFACTURE FLUID-STORING AND/OR -CARRYING MOTOR VEHICLE COMPONENTS

(71) Applicant: Röchling Automotive SE & Co. KG, Mannheim (DE)

(72) Inventors: Gloria Paoli, Riva del Garda (IT); Fabrizio Chini, Isera (IT)

(21) Appl. No.: 16/171,840

(22) Filed: Oct. 26, 2018

(30) Foreign Application Priority Data
Oct. 30, 2017 (DE) 10 2017 219 459.6

(51) Int. Cl. C08J 3/22; C08K 3/013; B29B 13/02

(52) U.S. Cl. CPC C08J 3/22; C08K 3/013; C08K 2201/01; C08J 2300/22; C08J 2323/00; B29B 13/022

(57) ABSTRACT

Use of a plastic containing an antimicrobial active substance to manufacture motor vehicle components that are embodied to store and/or to convey fluids.

The present invention relates to the use of a plastic containing an antimicrobial active substance to manufacture motor vehicle components that are embodied to store and/or to convey fluids.

### BACKGROUND OF THE INVENTION

In motor vehicles, numerous liquids are stored in tanks and are directed, via conduits coupled to the tank, to a predetermined utilization location in the motor vehicle. A motor vehicle also comprises numerous climate-control conduits in which climate-controlled air is directed into spaces of the motor vehicle, in particular into the passenger compartment where the climate-controlled air can be directly inhaled by occupants of the respective motor vehicle. One aspect of climate control relates to the furnishing of climate-controlled air at a desired temperature level. A further aspect of climate control relates to establishing a desired or predetermined moisture level in the air delivered into the vehicle interior.

Although pure water is at present furnished fairly seldom in motor vehicle tanks, liquids furnished in the motor vehicle are not necessarily permanently sterile. One reason for this is that to an increasingly large extent, liquids furnished in a motor vehicle must be environmentally compatible, and the ingredients and additives contained therein therefore do not necessarily kill germs that get into the liquid, or prevent them from reproducing. Another reason can be that germs can also survive and reproduce in a fluid environment having a pH value deviating from neutral, i.e. in an alkaline or acid environment.

### SUMMARY OF THE INVENTION

In the present case the use addressed above relates in particular to the use of a plastic containing an antimicrobial active substance to manufacture a tank for storing, and/or a conduit for conveying, water that is provided and intended for injection into the internal combustion engine. Water injection serves, for example, to decrease emissions and/or to decrease knock susceptibility.

An objective addressed by the present invention is therefore that of decreasing, in motor vehicles, the risk of infection proceeding from undesired germs. This object is achieved according to the present invention by the use of a plastic that contains an antimicrobial active substance to manufacture motor vehicle components which are embodied to store and/or to convey fluids. The term “fluid” refers here to any kind of flowable medium, i.e. in particular gases and liquids.

An “antimicrobial active substance” is considered to be any active substance that is capable of killing microorganisms, for example bacteria, viruses, and fungi, and/or preventing reproduction and/or quantitative growth thereof.

Possible antimicrobial active substances encompass metal/non-metal compounds such as metal oxides, in particular silver oxide, zinc oxide, and the like. When wetted with a fluid, these can discharge thereinto ions that attack microorganisms contained in the fluid. In addition to metal/non-metal compounds, pure metal can also have an antimicrobial effect. Copper, silver, brass, and aluminum may be recited here. The plastic can therefore also encompass nanoparticles of pure metal or of a metal alloy, in particular copper, silver, brass, and aluminum, or of an alloy whose principal constituent is one or several of the aforesaid metals.

A plastic having an antimicrobial active substance can be used in particularly simple fashion to manufacture fluid-storing and/or fluid-carrying motor vehicle components by the fact that the plastic comprises an antimicrobial masterbatch that is mixed into the plastic. The antimicrobial masterbatch itself is generally obtained by mixing an antimicrobial active substance into a basic masterbatch material.

Antimicrobial masterbatches of this kind are offered by many companies for applications in medical technology. A preferred antimicrobial masterbatch is obtainable, for example, under the commercial name “ABATOX” from Bio Eco Active s.r.l. in Granarolo dell'Emilia (IT). A further antimicrobial masterbatch usable in the present instance is available under the commercial name “ABACT” from the A. Schulman company in Akron, Ohio (US). An antimicrobial masterbatch is also obtainable under the name “ROWA PROTECT” from Rowa Masterbatch GmbH in Pinneberg (DE). It is based on zinc oxide and can be mixed as a masterbatch into any plastic, in particular any thermoplastic. The use of antimicrobial masterbatches allows highly accurate metering of the antimicrobial active substance immediately before the plastic influenced by the masterbatch is reshaped on the part of the plastic-processing enterprise, which can generate the mixture in a conventional compounder facility. One or several additives, for example color pigments, can be mixed into the base polymer in addition to the antimicrobial masterbatch. The masterbatch, and if applicable the further additives, can be mixed in gravimetrically, i.e. in weight-based fashion, by weighing out the individual components of the plastic that is later to be processed.

Further antimicrobial masterbatches are known to be obtainable from Biesterfeld Plastic GmbH in Hamburg (DE), from TITK in Rudolstadt (DE), or from Bio-Gate AG in Nuremberg (DE).

It is not to be precluded in principle that the plastic used to manufacture the aforesaid motor vehicle components can be any plastic, for example a thermosetting plastic or an impregnated fiber material, or a fiber composite material made of thermoplastic material and dimensionally stable reinforcing fibers. Because a high degree of deformation is advantageous specifically in the sector of fluid-storing and/or fluid-carrying motor vehicle components, the plastic is preferably a thermoplastic, in particular a thermoplastic elastomer and/or a polyolefin.

The present invention also refers to a motor vehicle component that is embodied to store and/or to carry or convey fluid in the motor vehicle. A motor vehicle component of this kind can be, for example, a tank or tank body, a tube or tubular body, or a hose or hose body. The tank body can be supplemented with further components or component segments to yield a tank. The same is correspondingly true of tubular bodies and hose bodies.

In order to achieve the desired antimicrobial effect it is sufficient if the motor vehicle component comprises, at least on its boundary surface wetted by fluid during operation as intended, a plastic that contains an antimicrobial active substance.

Because the plastic material that contains the antimicrobial active substance essentially represents the reservoir of antimicrobial active substance, however, it is advantageous if a wall of the motor vehicle component which comprises the boundary surface is constituted over its entire thickness from the plastic having an antimicrobial active substance. The relevant plastic of the motor vehicle component can, as a result, deliver antimicrobial active substance for a longer period to the fluid that is wetting it.

This applies to plastic materials that deliver antimicrobial active substance. The antimicrobial active substance in the plastic can, however, also modify the latter in terms of its electrical, in particular electrostatic, properties, and thereby prevent deposition (which promotes reproduction) of microorganisms onto the plastic surface. The surface of the plastic correspondingly equipped with antimicrobial active substance thus acquires, as a result of ions incorporated in stationary fashion, an electrostatic charge that acts in repelling fashion on the surface of cell structures of microorganisms that can have, locally externally, an electric charge of the same polarity as that of the ions incorporated into the plastic.

As already stated with regard to use, the plastic can at least be constituted from a plastic that is free of antimicrobial active substance and from an antimicrobial masterbatch mixed into the active substance-free plastic. It can also be mixed directly into a basic plastic material from which at least some of the motor vehicle component becomes or is manufactured.

The present invention further relates to a method for manufacturing a fluid-storing and/or fluid-carrying motor vehicle component, for example a tank, tank body, tube, tubular body, and/or hose or hose body. According to the present invention the method encompasses the following method steps:
mixing an antimicrobial active substance into a basic plastic material, in particular into a plastic granulate;
reshaping the plastic, comprising the antimicrobial active substance, into at least a portion of the motor vehicle component embodied to store and/or to convey fluid, in such a way that the portion constitutes at least one boundary surface, wetted by fluid in the context of operation of the motor vehicle component as intended, of the motor vehicle component.

In order to achieve high accuracy, in particular high repeat accuracy, in terms of mixing, the antimicrobial active substance is preferably mixed gravimetrically into the basic plastic material.

The antimicrobial active substance is preferably coupled to at least one tracing substance in order to simplify quality assurance of the manufactured antimicrobial motor vehicle component. A tracing substance of this kind can be, for example, a dye or a fluorescent material, so that the concentration of antimicrobial active substance therein can be checked by way of the coloring of the motor vehicle component or component portion, for example using a color spectrometer. Additionally or alternatively, the tracing substance can encompass solid particles other than color pigments or fluorescent pigments, for example ferromagnetic particles. In a quality assurance step that can take place after the reshaping step, all those components whose tracing value, with regard to tracing of the tracing substance coupled to the antimicrobial active substance, lies outside a predetermined range of tolerance values or acceptance values can be rejected.

The reshaping step can encompass only coating of an already existing motor vehicle component portion. For the reasons already recited above, the reshaping step preferably encompasses manufacture of a tank body and/or of a tubular body and/or of a hose body from the plastic containing the antimicrobial active substance.

The motor vehicle component can encompass both plastic comprising the antimicrobial active substance and plastic that is free of antimicrobial active substance. Preferably, however, those portions of the motor vehicle component which contain antimicrobial active substance are constituted entirely from the plastic that contains antimicrobial active substance. The statements above relate to a component that is manufacturable using a reshaping method step. A motor vehicle component made of a plastic that contains antimicrobial active substance can of course have mounted onto it a further component that is free of antimicrobial active substance. This does not, however, relate (any longer) to the manufacture of a motor vehicle component by reshaping.

Because a thermoplastic having antimicrobial active substance is preferred due to the desired high degree of reshaping and/or in order to furnish the capability of overmolding a component portion, according to an advantageous refinement of the present invention the reshaping step encompasses melting of plastic, in particular in granulated form, and a step of blow-reshaping and/or injection molding and/or extruding. The injection molding can encompass or be an overmolding of an existing component portion.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWING

The invention may take physical form in certain parts and arrangement of parts, a preferred embodiment of which will be described in detail and illustrated in the accompanying drawing which form a part hereof and wherein:

FIG. 1 shows a liquid tank as an example of a fluid-storing motor vehicle component.

### DESCRIPTION OF PREFERRED EMBODIMENTS

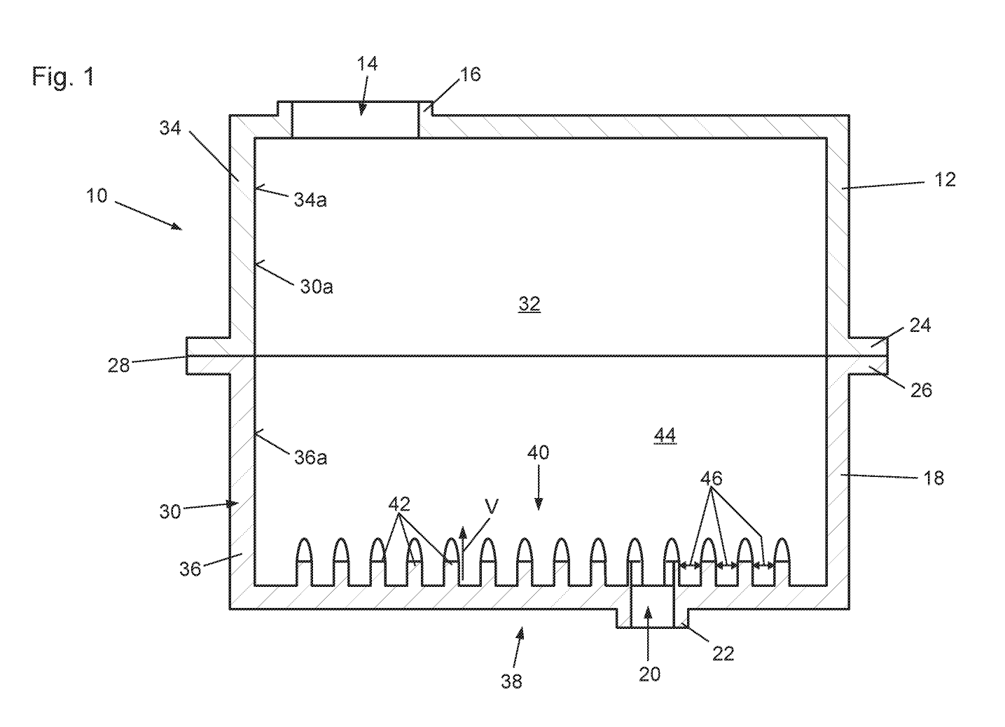

Referring now to the drawing wherein the showings are for the purpose of illustrating preferred and alternative embodiments of the invention only and not for the purpose of limiting the same, FIG. 1 shows a liquid tank according to the present invention that is labeled in general as 10. Liquid tank 10 preferably encompasses an upper shell part 12 that comprises a filler opening 14 having a flanged rim 16 surrounding filler opening 14. A filler conduit, for example a filling tube (not depicted in FIG. 1), can be connected to flanged rim 16.

Liquid tank 10 furthermore encompasses a lower shell part 18 that comprises a withdrawal opening 20 having a flanged rim 22 surrounding withdrawal opening 20. A withdrawal conduit (not depicted in FIG. 1) can in turn be connected to flanged rim 22.

Upper shell part 12 and lower shell part 19 are preferably joined to one another, for example adhesively bonded or welded, along a respective peripheral joining flange 24, 26. Joining flanges 24 and 26 contact one another along a joining surface 28 that is preferably flat.

Tank 10 comprises a tank wall 30 that surrounds a tank volume 32 of tank 10. Tank wall 30 is constituted on the one hand by wall 34 of upper shell part 12, and constituted on the other hand by wall 36 of lower shell part 18.

An inner side 30a of tank wall 30 constitutes a delimiting surface of the tank wall with respect to tank volume 32. Inner side 30a in turn is constituted on the one hand by inner side 34a of wall 34 of upper shell part 12, and constituted on the other hand by inner side 36a of wall 36 of lower shell part 18.

In a departure from the example depicted, liquid tank 10 can of course comprise more than two shell parts, or can also be embodied in one piece, for example by blow molding.

In a bottom portion 38 of tank 10, more precisely of lower shell part 18, a relief structure 40 is shaped, on inner side 30a facing toward tank volume 32 or 36a, so as to face toward tank volume 32. Relief structure 40 is shaped integrally and materially continuously with tank 10, in particular with lower shell part 18.

Like upper shell part 12, lower shell part 18 is preferably manufactured by injection molding.

In the example depicted, relief structure 40 formed directly upon injection molding of lower shell part 18 encompasses identical protrusions 42 that project in a protrusion direction V into tank volume 32, away from bottom portion 38 of lower shell part 18. In the example depicted, projections 42 extend parallel to one another, with a substantially uniform height regardless of location, in an extension direction orthogonal to the drawing plane of FIG. 1. For example, projections 42 can also extend a little way along side wall 44 toward joining surface 28, so that they have a greater height at side wall 44 than in a portion between mutually oppositely located side walls which is located at a distance from side wall 44.

Directly adjacent projections 42 are arranged at a distance from one another by way of spacings 46 in a direction orthogonal both to protrusion direction V and to the extension direction of projections 42. The spacing direction in FIG. 1 is parallel to the drawing plane. The projections can exhibit, in their extent between two side walls, one or two passages in order to allow spillover from a region between two projections into an adjacent region of that kind. The passages preferably have an unobstructed width that is no greater than twice the average thickness of the projection. Passages of projections immediately adjacent to one another are preferably embodied with an offset from one another in a longitudinal direction of the projections, so that liquid cannot flow in a straight line, without deflection, past two directly adjacent projections.

In the example depicted, all projections 42 are preferably identical to one another, as are spacings 46 between adjacent projections 42.

In the example depicted, spacings 46 are slightly larger than the thickness, to be measured in the same direction, of projections 42. Spacings 46 are dimensioned so that they are too large for the formation of capillary effects between mutually facing side walls of directly adjacent projections 42, and so that they are too small for the formation of appreciable liquid flows in a spacing direction in the sub-volumes located between directly adjacent projections 42.

The thickness of projections 42 is selected so that they are stable over the expected operational service life of liquid tank 10.

In terms of the selection of usual materials for manufacturing upper shell 12 and lower shell 18, i.e. for example thermoplastics, an optimum ratio that results between projection thickness and spacing 46, to be measured in the same direction, between two adjacent projections 42 is approximately from 0.2 to 3. In the example depicted, the ratio of projection thickness to spacing 46 is slightly less than 1, approximately 0.85, since spacing 46 is slightly larger than the thickness of the associated projections 42.

Shell parts 12 and 18 can each be manufactured in an injection mold in one step, and then joined to one another at their joining flanges 24 and 26. Relief structure 40 is constituted directly during reshaping manufacture of lower shell part 18. This eliminates any need to configure a relief structure on a separate component and connect the component to one of shell parts 12 and 18, thus minimizing the outlay for manufacturing liquid tank 10 presented here.

Alternatively, lower shell 18 can be configured without relief structure 40 and can have a smooth bottom.

According to the present invention, at least lower shell part 18 is, preferably both shell parts 12 and 18 are, constituted from a thermoplastic material that contains an antimicrobial active substance, for example a silver compound or a zinc compound. It is thereby possible to prevent microbial pathogens from reproducing in the tank or in conduits connecting thereto, and contaminating or infecting humans.

For this purpose, in simple fashion a plastic granulate that is free of antimicrobial active substance can be procured and can be mixed with an antimicrobial masterbatch prior to reshaping. Further additives, for example color pigments, can additionally be mixed in as necessary or as desired. The colored or fluorescent pigments are preferably coupled to the antimicrobial active substance so that the completed component can be checked with a color spectrometer for the presence of a correct quantity of antimicrobial active substance.

In principle, liquid tank 10 depicted in FIG. 1 can receive any liquids, in particular operating liquids of motor vehicles. Particularly preferably, liquid tank 10 is a water tank that is embodied and intended for the reception of water that is in turn intended for injection into the internal combustion engine in the motor vehicle. Water injection serves to reduce emissions and/or to decrease knock susceptibility.

Because the liquid contained therein is injected into the exhaust system, this water tank does not represent an immediate risk of contamination or infection for the occupants of the vehicle carrying the tank; but on the one hand a maintenance person may come into contact with bacterially contaminated liquid, and on the other hand microorganisms that have sufficiently reproduced can undesirably clog conduits and/or nozzles and/or filters and/or pumps, and/or can attack material involved in the injection apparatus, and thereby interfere with injection.

A further advantageous use of the present invention consists in the constitution of storage and conveyance components of motor vehicle climate-control systems from plastic equipped with antimicrobial active substance. The conduits of the motor vehicle climate control system deliver climate-controlled, in particular moisture-conditioned, air into the passenger compartment of a motor vehicle, with the result that that air is directly inhaled by occupants and thereby travels into their bodies.

During a shutoff phase of the motor vehicle, condensation water can condense onto the conduit walls; without the feature proposed according to the present invention, microbial germs can reproduce in that water and can be blown into the passenger compartment when the climate control system is again put into service. Germ reproduction in the conduits can be effectively suppressed or even prevented by the use of a plastic to which antimicrobial active substance has been added.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-10. (canceled)

11. Use of a plastic containing an antimicrobial active substance to manufacture motor vehicle components that are embodied to store and/or to convey associated fluids.

12. The use according to claim 11, wherein the plastic comprises an antimicrobial masterbatch that is mixed into the plastic.

13. The use according to claim 12, wherein the plastic is a thermoplastic.

14. The use according to claim 13, wherein the plastic is at least one of a thermoplastic elastomer and a polyolefin.

15. The use according to claim 11, wherein the plastic is a thermoplastic.

16. The use according to claim 15, wherein the plastic is at least one of a thermoplastic elastomer and a polyolefin.

17. The use according to claim 11, wherein the antimicrobial active substance is coupled to a tracing substance.

18. The use according to claim 17, wherein the tracing substance includes at least one of a color pigment, a fluorescent pigment and ferromagnetic particles.

19. A motor vehicle component that is embodied to store and/or to convey fluid, for example, a tank, a conveying tube, and/or a conveying hose, wherein the motor vehicle component comprises, at least on its boundary surface wetted by an associated fluid during operation as intended, a plastic that contains an antimicrobial active substance.

20. The motor vehicle component according to claim 19, wherein the plastic is at least constituted from a plastic that is free of antimicrobial active substance, and from an antimicrobial masterbatch mixed into the active substance-free plastic.

21. The motor vehicle component according to claim 20, wherein a wall of the motor vehicle component which comprises the boundary surface is constituted over its entire thickness from the plastic having an antimicrobial active substance.

22. The motor vehicle component according to claim 19, wherein a wall of the motor vehicle component which comprises the boundary surface is constituted over its entire thickness from the plastic having an antimicrobial active substance.

23. A method for manufacturing a motor vehicle component according to claim 19, wherein the method comprises the following steps:
mixing an antimicrobial active substance into a plastic
reshaping the plastic, comprising the antimicrobial active substance, into at least a portion of the motor vehicle component embodied to store and/or to convey fluid, in such a way that the portion constitutes at least one boundary surface, wetted by fluid in the context of operation of the motor vehicle component as intended, of the motor vehicle component.

24. The method according to claim 23, wherein the mixing step is mixing the antimicrobial active substance into a plastic granulate.

25. The method according to claim 23, wherein the reshaping step encompasses manufacture of a tank body and/or of a tubular body and/or of a hose body.

26. The method according to claim 23, wherein the reshaping step includes melting of the plastic into a melted plastic and a step of blow-reshaping and/or injection molding and/or extruding the melted plastic.

27. The method according to claim 24, wherein the reshaping step includes melting the plastic granulate into a melted plastic, and a step of blow-reshaping and/or injection molding and/or extruding the melted plastic.
